(19) United States
(12) Patent Application Publication
(10) Pub. No.: US 2008/0117176 A1
(43) Pub. Date: May 22, 2008

(54) ELECTRONIC DEVICES HAVING A TOUCH SCREEN AND METHOD FOR STARTING THE ELECTRONIC DEVICES

(75) Inventors: CHUNG-YANG KO, Tu-Cheng (TW); CHIN-FENG CHEN, Tu-Cheng (TW); TAY-YANG LIN, Tu-Cheng (TW); YUAN-HUNG CHIEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/843,660

(22) Filed: Aug. 23, 2007

(30) Foreign Application Priority Data
Nov. 20, 2006 (CN) 200610201119.0

(51) Int. Cl. G06F 3/041

(52) U.S. Cl. 345/173

(57) ABSTRACT

An exemplary electronic device (10) comprises a display (11), a chip controller (131), a power supply (14) and a main processor (12). The display has a touch screen (111). The power supply is electrically connected to and controlled by the chip controller. The main processor is electrically connected to the chip controller. The main processor is used to store a start operational input and calculate a touched signal that the touch screen is touched. The main processor further compares the touched signal with the start operational input to decide whether to send a start instruction the chip controller to start the electronic device. The present invention further provides a method for starting the electronic device.

### CROSS-REFERENCE TO RELATED APPLICATIONS

This application is related to four co-pending U.S. Patent Applications (Attorney Docket No.US11801, US11803, US11804, US11805), all entitled “ELECTRONIC DEVICES HAVING A TOUCH SCREEN AND METHOD FOR STARTING THE ELECTRONIC DEVICES”, by Chung-Yang Ko et al. Such applications have the same assignee as the instant application and are concurrently filed herewith. The disclosure of the above-identified applications is incorporated herein by reference.

### BACKGROUND OF THE INVENTION

1. Field of the Invention

The present invention relates to electronic devices having a touch screen and methods for starting the electronic devices.

2. Discussion of the Related Art

Nowadays, electronic devices are popular and are used in a variety of situations. However, electronic devices also carry certain risks. For example, personal information stored in electronic devices such as mobile phones, personal digital assistants (PDAs) and personal computers may be stolen by others.

One typical electronic device includes an on/off key and a lock/unlock key. These keys can be actuated by anyone, thus, information stored in the electronic device can be easily accessed and used for malicious purposes. In order to keep information secured, passwords need to be inputted for turning on or unlocking the electronic device. However, inputting passwords often involves typing several letters and/or numbers on a keyboard, making the procedure very inconvenient.

Therefore, a need exist for electronic devices that can conveniently be turned on or unlock, to keep information secured, and the methods thereof.

### SUMMARY

An exemplary electronic device includes a display having a touch screen, a chip controller, a power supply and a main processor. The power supply is electrically connected to and controlled by the chip controller. The main processor is electrically connected to the touch screen and the chip controller. The main processor is used to store a start operational input including at least one of a predetermined touched position, a predetermined touched duration, and a predetermined number of touched times and calculate a touched signal including at least one of touched position, touched duration, and number of touched times that the touch screen is touched. The main processor is used to further compare the touched signal with the start operational input to decide whether to send a start instruction to the chip controller to start the electronic device.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present electronic device and method for starting the electronic device, and associated electronic device. Moreover, in the drawings, like reference numerals designate corresponding parts throughout the several views, and all the views are schematic.

FIG. 1 is a schematic view of an electronic device in accordance with an exemplary embodiment of the present invention.

FIG. 2 is a view showing a working principle of a touch screen of the electronic device of FIG. 1.

FIG. 3 is a top plan view of the touch screen of FIG. 2 divided by imaginary lines.

FIG. 4 is a flow chart of starting the electronic device of FIG. 1.

### DETAILED DESCRIPTION OF THE EMBODIMENTS

The present invention provides an electronic device, such as a mobile phone or a personal digital assistant (PDA), and a method for starting the electronic device.

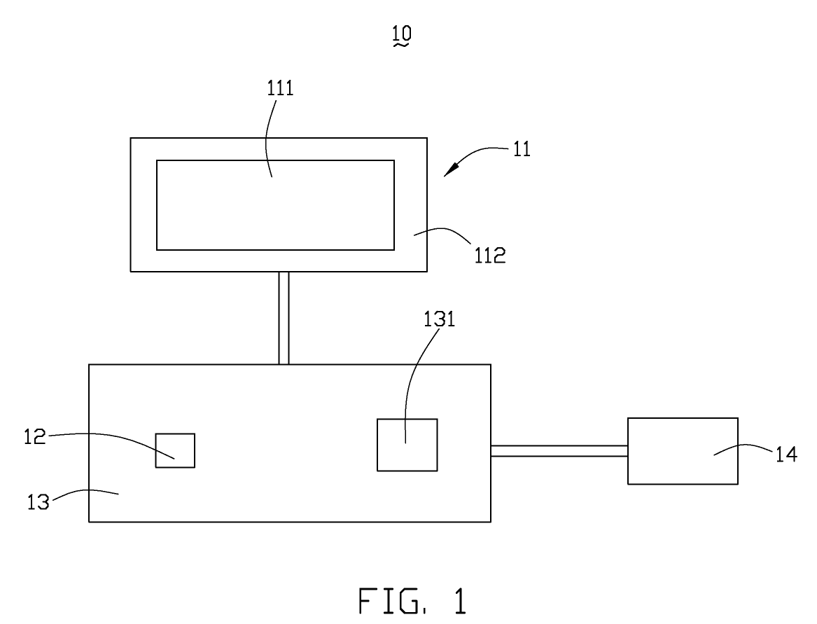

Referring to FIG. 1, an electronic device 10 includes a display 11, a main processor 12, a circuit board 13, and a power supply 14. The display 11 includes a frame 112 and a touch screen 111 confined within the frame 112. A chip controller 131 is mounted on the circuit board 13. The main processor 12 is mounted on the circuit board 13. The display 11 is electrically connected to the main processor 12 via the circuit board 13, and the power supply 14 is electrically connected to the chip controller 131 via the circuit board 13. The chip controller 131 is electrically connected to the main processor 12 via the circuit board 13. Alternatively, the main processor 12 can also be outside the circuit board 13 and directly connected to the display 11 and the power supply 14.

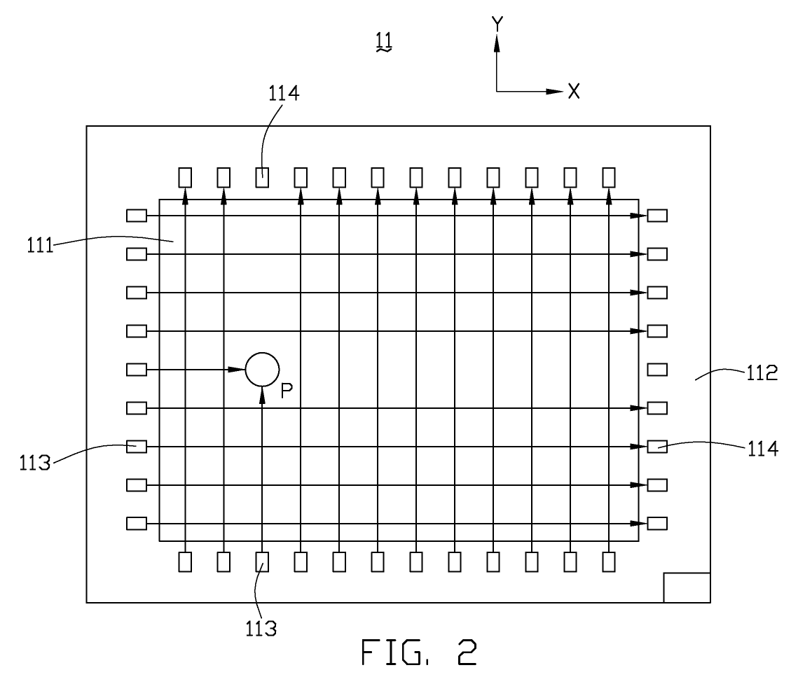

Also referring to FIG. 2, the touch screen 111 is an IR (infrared) touch screen. The display 11 further includes a plurality of photodiode-photosensor pairs arranged around the touch screen 111 in a way such that a photodiode 113 and a photosensor 114 of a photodiode-photosensor pair are aligned on opposite sides of the display 11. In a preferred embodiment, as depicted in FIG. 2, two adjacent sides of the touch screen 111 are arranged with either an array of photodiodes 113 or an array of photosensors 114. Furthermore, each photosensor 114 is assigned a unique coordinate value that corresponds to the position of the photodiode-photosensor pair relative to the frame 112. In the illustrated embodiment, the frame 112 and the touch screen 111 are quadrilateral in shape. Two adjacent sides of the touch screen 111 are arranged with photodiodes 113 and the other two adjacent sides of the touch screen 111 are arranged with photosensors 114. Adjacent photodiode-photosensor pairs at opposite sides of the display 11 are separated from each other by a same distance. The photodiodes 113 and the photosensors 114 are connected to the main controller 12.

How the touch screen 111 works is described hereinafter. An infrared ray is transmitted by the photodiode 113 and received by the photosensor 114 in a same photodiode-photosensor pair. The infrared ray is transmitted and received in each of the photodiode-photosensor pairs. When an object is in a path of the infrared ray, the infrared ray is interrupted and the photosensor 114 would not be able to receive the infrared rays. For example, referring to FIG. 2, when the touch screen 111 is touched at point P by an object, the object would interrupt the infrared rays traveling through point P, thus affected photosensors 114 (top and right side) would be unable to receive the infrared rays. The main processor 12 detect which photosensors 114 did not receive the infrared rays and records the coordinates of the affected photosensors 114, thus computing the position of point P. A number of touched times (i.e., the touch screen 111 is touched for two times or three times etc.) of the touching can also be calculated by the main processor 12 according to the number of times the corresponding photosensors 114 cannot receive infrared rays. Thereby, the main processor 12 calculates a touched signal including the touched area, the touched duration, and the number of touched times.

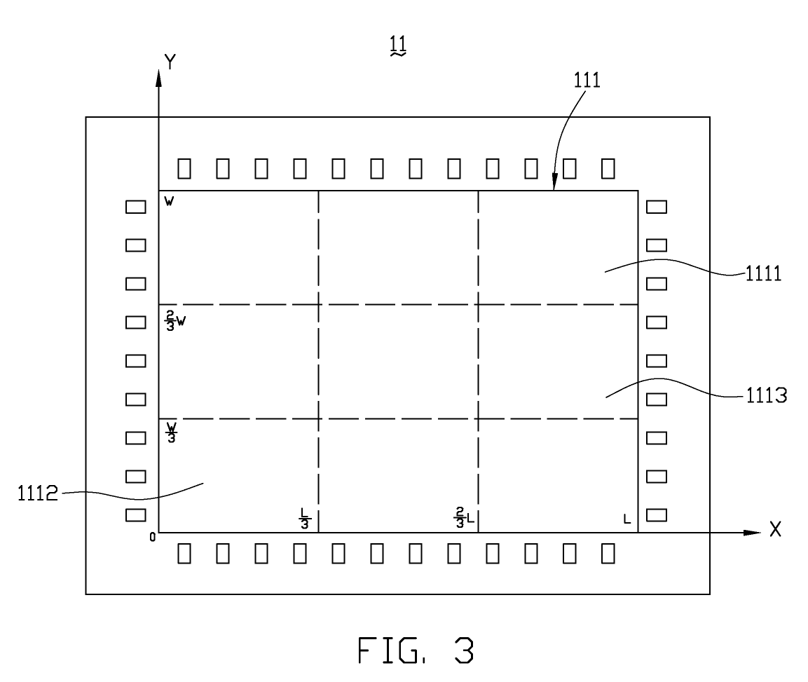

Referring to FIG. 3, the touch screen 111 of the electronic device 10, controlled by the main processor 12, is divided into several areas including areas 1111, 1112 and 1113. The touch screen 111 with a length of “L” in an X-axis direction and a width of “W” in a Y-axis direction is divided into nine areas, each of the nine areas having a length of “L/3” in the X-axis direction and a width of “W/3” in the Y-axis direction. Alternatively, the touch screen 111 can also be divided into any number of areas such as four or more than four areas. For each area, the area is regarded as touched when any point in the area is touched.

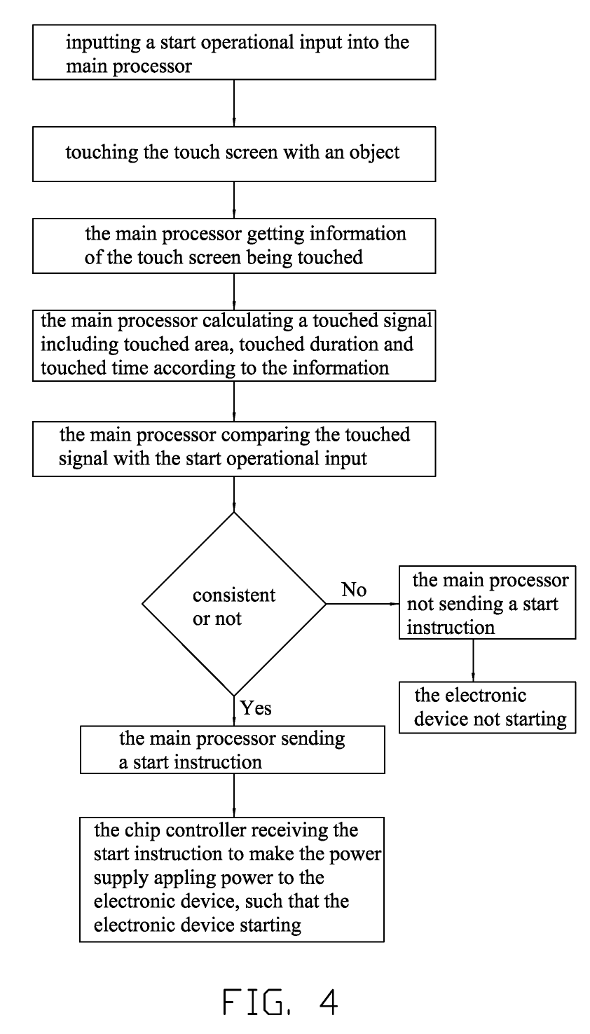

Also referring to FIG. 4, a method for starting the electronic device 10 is provided as below:
(1) A start operational input including a predetermined touched area, a predetermined touched duration, and a predetermined number of touched times is inputted into and stored in the main processor 12;
(2) An object such as a finger touches the touch screen 111;
(3) As described above, the main processor 12 gets the information of which photosensor 114 receives infrared rays and which photosensor 114 does not receive infrared rays;
(4) The main processor 12 calculates a touched signal including the touched area, the touched duration and number of touched times; and
(5) The main processor 12 compares the touched signal with the start operational input. If the touched signal is the same as the start operational input, the main processor 12 generates and sends the start instruction to the chip controller 131 of the circuit board 13 to make the power supply 14 applying power to the touch screen 111. Then the electronic device 10 starts (including turn on or unlock). If the touched signal is different from the start operational input, the electronic device 10 does not start.

Referring to FIG. 3 again, for example, the start operational input includes: simultaneously touching areas 1111, 1112 for at least five seconds three times. That is, only when areas 1111, 1112 are simultaneously touched for at least five seconds three times, the main processor 12 sends a start instruction and the electronic device 10 starts. If areas 1111, 1113 are simultaneously touched for at least five seconds three times, the main processor 12 compares the touched signal with the start operational input. The main processor 12 does not send any start instruction for starting the electronic device 10 since the touched area of the touched signal is not consistent with the predetermined touched area of the start operational input. When areas 1111, 1112 are simultaneously touched for three seconds three times, the main processor 12 does not send any start instruction for starting the electronic device 10 because the touched duration of the touched signal is not consistent with the predetermined touched duration of the start operational input. When areas 1111, 1112 are simultaneously touched for at least five seconds twice, the main processor 12 does not send any start instruction for starting the electronic device 10 because the number of touched times of the touched signal is not consistent with the predetermined number of touched times of the start operational input.

The electronic device can also be started or unlocked by using one or two of the three predetermined touch values. In other words, the start operational input signal may be activated using one or two of the touch values instead of all three. For example, the start operational input includes the predetermined touched area, only. With this condition, no matter how long and how many times the touch screen 111 is touched as long as the touched position is consistent with the touched area of the start operational input, the main processor 12 sends the start instruction for starting the electronic device 10. Thus, only one start operational input is needed for the turn on or unlock signal. With this condition, the main processor 12 always compares the touched signal with the start operational input to turn on or unlock the electronic device 10. In another example, the start operational input includes two touch values, a predetermined touched area and a predetermined touched duration. With this condition, no matter how many times the touch screen 111 is touched as long as the touched position and the touched duration are consistent with the touched area and the touched duration, of the start operational input, the main processor 12 sends the start instruction for starting the electronic device 10. Thus, only two values, of the start operational input, are needed to turn on or unlock the electronic device 10.

Additionally, a start operational input may be used for turning on the electronic device and a different start operational input may be used for unlocking the electronic device. With this condition, the main processor 12 compares the touched signal with one of the start operational inputs regarded as the turning on signal to turn on the electronic device 10 and compares another touched signal with the other start operational input regarded as the unlocking signal to unlock the electronic device 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device comprising:
a display having a touch screen;
a chip controller;
a power supply electrically connected to and controlled by the chip controller; and
a main processor electrically connected to the touch screen and the chip controller, the main processor being used to store a start operational input including at least one of a predetermined touched position, a predetermined touched duration, and a predetermined number of touched times and outputting a touched signal including at least one of touched position, touched duration, and number of touched times that the touch screen is touched, the main processor being used to further compare the touched signal with the start operational input to decide whether to send a start instruction to the chip controller to start the electronic device.

2. The electronic device as claimed in claim 1, wherein the touch screen is an infrared touch screen, the display further comprises a plurality of photodiode-photosensor pairs arranged around the touch screen such that a photodiode and a photosensor of the photodiode-photosensor pair are aligned on opposite sides of the display, the photodiodes are configured to send infrared rays and the photosensors are configured to receive infrared rays from the corresponding photodiodes, the photodiodes and the photosensors are connected to the main controller respectively.

3. The electronic device as claimed in claim 2, wherein the display further comprises a frame, and the touch screen is confined within the frame.

4. The electronic device as claimed in claim 3, wherein the frame and the touch screen are quadrilateral in shape, the photodiodes are disposed near two adjacent sides of the frame with every two adjacent photodiodes on a same side having a same distance, the photosensors are disposed at two other adjacent sides of the frame opposite to the photodiodes.

5. The electronic device as claimed in claim 1, wherein the touch screen comprises several areas divided by the main processor.

6. The electronic device as claimed in claim 1 further comprising a circuit board, the main processor and the chip controller are electrically connected to the circuit board.

7. The electronic device as claimed in claim 1 further comprising a circuit board, the chip controller is electrically connected to the circuit board, and the main processor is positioned inside the display.

8. A method for starting an electronic device comprising:
providing an electronic device comprising a display, a chip controller, a power supply and a main processor, the power supply electrically connected to and controlled by the chip controller, the main processor electrically connected to the chip controller, the display having a touch screen;
inputting a start operational input including at least one of a predetermined touched position, a predetermined touched duration and a predetermined number of touched times into the main processor;
touching the touch screen;
the main processor getting information of the touch screen being touched;
the main processor deducing a touched signal including a touched position, touched duration and number of touched times according to the information, and the main processor comparing the touched signal with the start operational input;
the main processor sending a start instruction to the chip controller and the chip controller making the power supply applying power to start the electronic device if the touched signal being consistent with the start operational input.

9. The method as claimed in claim 8, wherein the touch screen is an infrared-light ray touch screen, the display further comprises a plurality of photodiode-photosensor pairs arranged around the touch screen in way such that a photodiode and a photosensor of a photodiode-photosensor pair are aligned on opposite sides of the display, the photodiodes send infrared rays, the photodiodes and the photosensors are connected to the main controller respectively, and infrared rays sent by the photodiodes facing the touched point are blocked by an object such that no infrared rays arrive at the photosensors corresponding to the photodiodes facing the touched point and the rest of the photosensors receive infrared rays.

10. The method as claimed in claim 9, wherein the display further comprises a frame, and the touch screen is confined within the frame.

11. The method as claimed in claim 10, wherein the frame and the touch screen are quadrilateral in shape, the photodiodes are disposed near two adjacent sides of the frame with every two adjacent photodiodes at a same side having a same distance, the photosensors are disposed at two other sides of the frame opposite to the photodiodes.

12. The method as claimed in claim 8, wherein information of the touch screen being touched is that which photosensor receives infrared rays and which photosensor does not receive infrared rays.
